(19) United States
(12) Patent Application Publication
(10) Pub. No.: US 2026/0048737 A1
(43) Pub. Date: Feb. 19, 2026

(54) VEHICLE CONTROLLER, METHOD, AND COMPUTER PROGRAM FOR VEHICLE CONTROL

(71) Applicants: TOYOTA JIDOSHA KABUSHIKI KAISHA, Toyota-shi (JP); DENSO CORPORATION, Kariya-city (JP)

(72) Inventor: Satoru AKAHANE, Machida-shi (JP)

(73) Assignees: TOYOTA JIDOSHA KABUSHIKI KAISHA, Toyota-shi (JP); DENSO CORPORATION, Kariya-city (JP)

(21) Appl. No.: 19/289,655

(22) Filed: Aug. 4, 2025

(30) Foreign Application Priority Data
Aug. 14, 2024 (JP) 2024-135379

(51) Int. Cl. B60W 30/09; G06V 20/58; G06V 20/59

(52) U.S. Cl. CPC B60W 30/09; B60W 2420/403; B60W 2540/229; B60W 2540/26; B60W 2556/40; B60W 2720/106; G06V 20/582; G06V 20/597

(57) ABSTRACT

A vehicle controller includes a processor configured to detect abnormality occurring in a driver of a vehicle, determine whether an evacuation space exists within a predetermined range of a current position of the vehicle, when abnormality occurring in the driver is detected, by referring to map information or by recognizing a traffic sign indicating the existence of the evacuation space from a vehicle exterior image, and control the vehicle when the evacuation space exists within the predetermined range so that the vehicle stops in the evacuation space and that a first amount of slowdown of the vehicle before starting an entry action to make the vehicle enter the evacuation space is less than a second amount of slowdown from the start of the entry action to the stop of the vehicle.

### FIELD

The present invention relates to a vehicle controller that controls travel of a vehicle when abnormality occurs in a driver, a method, and a computer program for vehicle control.

### BACKGROUND

A travel controller that evacuates a vehicle to an appropriate position in the event of abnormality of a driver of the vehicle has been researched (see Japanese Unexamined Patent Publication No. 2018-43705). When a driver's abnormal state is detected during travel of a host vehicle on a downward slope, the travel controller sets an area ahead on the travel path to which the host vehicle will evacuate to stop as a forward evacuation use area. The travel controller then detects an object that can hinder movement of the host vehicle after the stop in the forward evacuation use area as an evacuation use object, sets a target course along which the host vehicle will travel to the evacuation use object, and controls travel so that the host vehicle travels along the target course and stops near the evacuation use object.

### SUMMARY

It is preferable that the time required from detection of a driver's abnormality until the vehicle stops be as short as possible.

It is an object of the present invention to provide a vehicle controller that can shorten the time required from sensing of a driver's abnormality until the vehicle stops.

According to an embodiment, a vehicle controller is provided. The vehicle controller includes a memory configured to store map information including information on an evacuation space to which a vehicle can evacuate; and a processor configured to: detect abnormality occurring in a driver of the vehicle, determine whether the evacuation space exists within a predetermined range of a current position of the vehicle, when abnormality occurring in the driver is detected, by referring to the map information or by recognizing a traffic sign indicating the existence of the evacuation space from a vehicle exterior image obtained by a vehicle exterior camera configured to capture an area around the vehicle, and control the vehicle when the evacuation space exists within the predetermined range so that the vehicle stops in the evacuation space and that a first amount of slowdown of the vehicle before starting an entry action to make the vehicle enter the evacuation space is less than a second amount of slowdown from the start of the entry action to the stop of the vehicle.

In an embodiment, when the evacuation space does not exist within the predetermined range, the processor decelerates the vehicle by a third amount of slowdown greater than the first amount of slowdown, searches for a stopping space where the vehicle can stop, based on the vehicle exterior image, and stops the vehicle in the stopping space.

In an embodiment, the processor sets a collision avoidance condition for starting an avoidance action to avoid the vehicle colliding with another object so that the collision avoidance condition is more relaxed after the start of the entry action than before the start of the entry action.

The vehicle controller of the present disclosure has an advantageous effect of being able to shorten the time required from sensing of a driver's abnormality until the vehicle stops.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit.

FIG. 3 is a functional block diagram of a processor of the electronic control unit, related to a vehicle control process.

FIG. 4 is a diagram for explaining the vehicle control process for the case where there is an evacuation space.

FIG. 5 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller has the function of an “emergency driving stop system (EDSS). ” When abnormality that makes it difficult for a driver to keep driving a vehicle is detected, the vehicle controller controls the vehicle according to emergency stop mode for automatically stopping the vehicle. To this end, the vehicle controller controls the vehicle so that a first amount of slowdown of the vehicle before starting an entry action to make the vehicle enter an evacuation space to which the vehicle can evacuate is less than a second amount of slowdown from the start of the entry action to the stop of the vehicle.

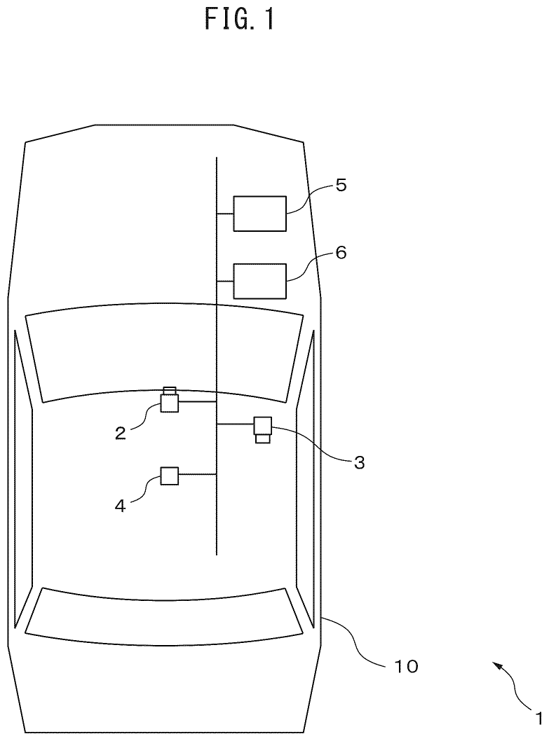

FIG. 1 schematically illustrates the configuration of a vehicle control system equipped with the vehicle controller. In the present embodiment, the vehicle control system 1, which is mounted on a vehicle 10 and controls the vehicle 10, includes a vehicle exterior camera 2, a driver monitoring camera 3, a GPS receiver 4, a storage device 5, and an electronic control unit (ECU) 6, which is an example of the vehicle controller. The vehicle exterior camera 2, the driver monitoring camera 3, the GPS receiver 4, and the storage device 5 are communicably connected to the ECU 6. The vehicle 10 may also include a range sensor (not illustrated) that measures the distances from the vehicle 10 to objects around the vehicle 10, such as LiDAR or radar. The vehicle 10 may further include a notification device (not illustrated) for notification to occupants of the vehicle 10. The vehicle 10 may further include a wireless communication terminal (not illustrated) for wireless communication with another device.

The vehicle exterior camera 2, which is an example of a vehicle exterior sensor, is mounted on the vehicle 10 so as to be oriented to a predetermined region in an area around the vehicle 10, such as a region in front of the vehicle 10. The vehicle 10 may include multiple vehicle exterior cameras taking pictures in different orientations or having different focal lengths. Every predetermined capturing period, the vehicle exterior camera 2 captures the predetermined region to generate an image representing the predetermined region (hereafter a “vehicle exterior image”) and outputs the generated vehicle exterior image to the ECU 6.

The driver monitoring camera 3 is an example of a vehicle interior sensor for sensing the driver's state. The driver monitoring camera 3 is mounted near the top of the windshield or near an instrument panel and oriented to the driver so that at least the head of the driver sitting on the driver's seat of the vehicle 10 is included in the region to be captured by the camera. The driver monitoring camera 3 may include a light source, such as an infrared LED. Every predetermined capturing period, the driver monitoring camera 3 captures the region to be captured to generate an image representing the driver (hereafter a “driver image”) and outputs the generated driver image to the ECU 6.

The GPS receiver 4 receives GPS signals from GPS satellites at predetermined intervals, and determines the position of the vehicle 10, based on the received GPS signals. The GPS receiver 4 outputs positioning information indicating the result of determination of the position of the vehicle 10 based on the GPS signals to the ECU 6 at predetermined intervals. The vehicle control system 1 may include a receiver conforming to another satellite positioning system, instead of the GPS receiver 4.

The storage device 5, which is an example of the storage unit, includes, for example, a hard disk drive or a nonvolatile semiconductor memory. The storage device 5 stores map information representing the position of a space to which the vehicle 10 can evacuate.

The ECU 6 functions as an EDSS. More specifically, when abnormality that prevents the driver from keeping driving the vehicle 10 is detected, the ECU 6 controls the vehicle 10 to make an emergency stop of the vehicle 10.

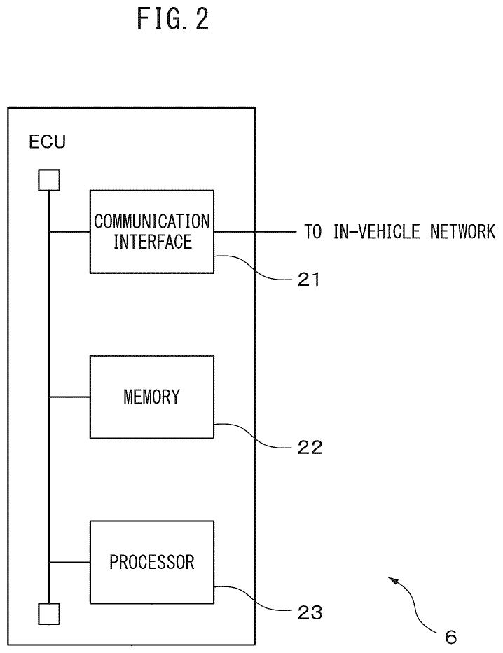

FIG. 2 illustrates the hardware configuration of the ECU 6. As illustrated in FIG. 2, the ECU 6 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 6 to another device inside the vehicle. The communication interface 21 passes a vehicle exterior image received from the vehicle exterior camera 2, a driver image received from the driver monitoring camera 3, and a positioning signal received from the GPS receiver 4 to the processor 23. The communication interface 21 also passes map information read from the storage device 5 to the processor 23. In addition, the communication interface 21 outputs a control signal for controlling the vehicle 10.

The memory 22, which is another example of the storage unit, includes, for example, volatile and nonvolatile semiconductor memories, and stores various types of data used in a vehicle control process executed by the processor 23 of the ECU 6. For example, the memory 22 stores parameters of the vehicle exterior camera 2, such as its mounted position, orientation, and focal length. The memory 22 also stores various parameters used for detecting the driver's abnormality from driver images. In addition, the memory 22 temporarily stores vehicle exterior images, driver images, positioning signals, and map information received from the vehicle exterior camera 2, the driver monitoring camera 3, the GPS receiver 4, and the storage device 5, respectively.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes a vehicle control process on the vehicle 10.

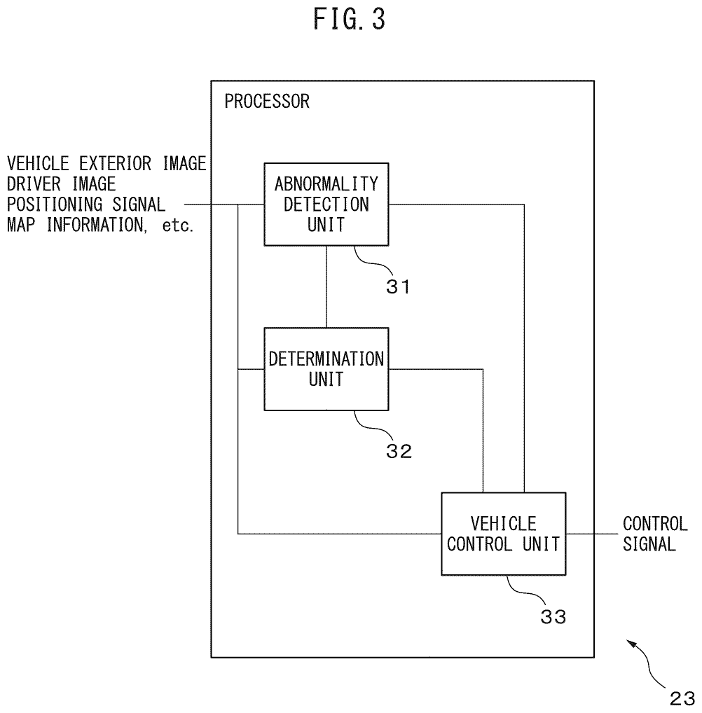

FIG. 3 is a functional block diagram of the processor 23, related to the vehicle control process. The processor 23 includes an abnormality detection unit 31, a determination unit 32, and a vehicle control unit 33. These units included in the processor 23 are, for example, functional modules implemented by a computer program executed by the processor 23, or may be dedicated operating circuits provided in the processor 23.

When abnormality that prevents keeping driving the vehicle 10 occurs in the driver, the abnormality detection unit 31 detects the abnormality. In the following, the fact that abnormality that prevents keeping driving the vehicle 10 has occurred in the driver will be referred to simply as “abnormality has occurred in the driver,” for convenience of description.

The abnormality detection unit 31 inputs driver images in the order of generation into a classifier that has been trained to detect various abnormalities of a driver. The classifier that detects the driver's abnormality is configured as a deep neural network (DNN) having a recursive structure, such as a recurrent neural network (RNN) or Long Short Term Memory (LSTM). The use of a DNN having a recursive structure as the classifier enables the abnormality detection unit 31 to use the driver's behavior depending on the driver's abnormality for detection of abnormality, enabling accurate detection of abnormality. The classifier may be configured based on another machine learning technique other than a DNN. The classifier is pre-trained in accordance with a predetermined supervised learning technique, such as backpropagation, using time-series images representing a driver in a normal state and multiple sets of time-series images prepared for respective types of abnormality to be detected and respectively representing a driver in these abnormal states as training images.

The abnormality detection unit 31 may detect the driver's abnormality in accordance with another technique for detecting abnormality occurring in a driver from driver images.

For example, the abnormality detection unit 31 determines the driver's sleepiness level at predetermined intervals, based on a series of driver images obtained in a most recent certain period. When the driver's sleepiness level is such that the driver cannot watch ahead of the vehicle 10, the abnormality detection unit 31 may determine that abnormality has occurred in the driver. To achieve this, the abnormality detection unit 31 detects the driver's looking direction and the degrees of opening of the eyes and the mouth (hereafter referred to as the “eye opening level” and the “mouth opening level,” respectively) of the driver from each of the series of driver images obtained in the most recent certain period. The abnormality detection unit 31 then determines the driver's sleepiness level, based on the detected looking direction, eye opening level, and mouth opening level. In this case, the abnormality detection unit 31 detects an eye region and a mouth region respectively representing the driver's eyes and mouth from each driver image by inputting each driver image into a classifier that has been trained to detect an eye region and a mouth region. For each driver image, the abnormality detection unit 31 calculates the ratio of the vertical size to the horizontal size of the eye region as an eye opening level and the ratio of the vertical size to the horizontal size of the mouth region as a mouth opening level. The abnormality detection unit 31 calculates the interval between maxima of the eye opening level from time-varying changes in the eye opening level in the series of driver images as the duration of the driver's single blink. The abnormality detection unit 31 then counts the number of blinks in the most recent certain period, and calculates the average of intervals between blinks as the period of a blink.

In addition, the abnormality detection unit 31 detects a pupillary centroid and a corneal reflection image of a light source (Purkinje image) by template matching of the eye region with templates representing a pupil and templates representing a Purkinje image. The abnormality detection unit 31 then calculates the direction and distance from the Purkinje image to the pupillary centroid, and refers to a table representing the relationship between the direction and distance and a driver's looking direction, thereby detecting the driver's looking direction. Such a table may be prestored in the memory 22. The abnormality detection unit 31 determines the amount of change in the looking direction for each pair of successive driver images in the most recent certain period, and divides the average of the amounts of change by the interval of acquisition of the driver images, thereby calculating the rate of change in the looking direction.

The abnormality detection unit 31 determines the driver's sleepiness level, based on at least one of the period and frequency of blinks, the mouth opening level, and the rate of change in the looking direction, and determines that abnormality has occurred in the driver when the sleepiness level is such that the driver cannot watch ahead of the vehicle 10. For example, the abnormality detection unit 31 determines that abnormality has occurred in the driver, in the case where the number of blinks in the most recent certain period is greater than or equal to a predetermined number, the period of a blink is longer than a predetermined time threshold, and the mouth opening level is higher than a predetermined opening level.

The abnormality detection unit 31 may determine whether abnormality has occurred in the driver, based on another index indicating the driver's state. For example, when a microphone (not illustrated) is provided in the vehicle interior, the abnormality detection unit 31 may detect a particular abnormal sound made by the driver (e.g., a snoring sound) from a voice signal generated by the microphone and representing a voice in the vehicle interior. The abnormality detection unit 31 may then determine that abnormality has occurred in the driver, when a particular abnormal sound made by the driver is detected. The abnormality detection unit 31 detects a particular abnormal sound made by the driver in accordance with one of techniques for detecting the abnormal sound from a voice signal.

When it is determined that abnormality has occurred in the driver, the abnormality detection unit 31 instructs the determination unit 32 and the vehicle control unit 33 to activate the EDSS function, i.e., to apply emergency stop mode. When it is determined that no abnormality has occurred in the driver, the abnormality detection unit 31 need not activate the EDSS function.

The determination unit 32 determines whether there is an evacuation space to which the vehicle 10 can evacuate within a predetermined range (e.g., a range of several hundred meters to several kilometers) of the current position of the vehicle 10 when the driver's abnormality is detected, i.e., when notified by the abnormality detection unit 31 that emergency stop mode will be applied. The evacuation space is, for example, a turnout prepared on a roadside in a descent section. Alternatively, the evacuation space may be an area prepared on a roadside where the vehicle 10 can stop, such as a service plaza, a parking area, or a place where tire chains are put on and removed.

The determination unit 32 determines whether an evacuation space is represented in the map information on the road section being traveled by the vehicle 10 within a predetermined range of the current position of the vehicle 10 indicated by the latest positioning information along the travel direction of the vehicle 10 indicated by an orientation sensor (not illustrated) mounted on the vehicle 10. When such an evacuation space is represented in the map information, the determination unit 32 determines that there is an evacuation space within the predetermined range of the current position of the vehicle 10.

Alternatively, the determination unit 32 may determine that there is an evacuation space, when a traffic sign indicating the existence of an evacuation space (hereafter an “evacuation sign”) can be recognized. In this case, the determination unit 32 detects an evacuation sign from a vehicle exterior image by inputting the vehicle exterior image into a classifier that has been trained to detect an evacuation sign. The classifier for detecting an evacuation sign is configured, for example, as a DNN having architecture of a convolutional neural network (CNN) type or an attention mechanism. When an evacuation sign is detected, the determination unit 32 detects a numerical value on the evacuation sign indicating the distance to an evacuation space. To achieve this, the determination unit 32 inputs a region representing the evacuation sign detected from a vehicle exterior image into a character recognizer. In this way, the determination unit 32 recognizes the distance to the evacuation space indicated by the evacuation sign. The character recognizer may also be configured as a DNN having CNN-type architecture or an attention mechanism. The classifier for detecting an evacuation sign may be integrated with the character recognizer used for recognizing the distance to an evacuation space indicated by an evacuation sign.

The determination unit 32 determines that there is an evacuation space within a predetermined range of the current position of the vehicle 10, in the case where an evacuation sign is detected from a vehicle exterior image, and where the distance to the evacuation space indicated by the evacuation sign is within the predetermined range of the current position of the vehicle 10.

When it is determined that there is an evacuation space, the determination unit 32 notifies the vehicle control unit 33 of the result of the determination and the position of the evacuation space.

The vehicle control unit 33, which is an example of the control unit, executes control according to emergency stop mode to stop the vehicle 10, when the driver's abnormality is detected, i.e., when notified by the abnormality detection unit 31 that emergency stop mode will be applied.

First, in a control announcement phase, the vehicle control unit 33 informs the surroundings of the vehicle 10 that the vehicle 10 will make an emergency stop. To achieve this, the vehicle control unit 33 turns on the hazard lights, and notifies the occupants of the vehicle 10 that emergency stop mode will be executed, via a notification device (not illustrated).

After a predetermined period (e.g., several seconds) in the control announcement phase, the vehicle control unit 33 stops the vehicle 10 at a target stopping position in a driving intervention phase. When notification of the result of determination that there is an evacuation space and the position of the evacuation space is given by the determination unit 32, the vehicle control unit 33 sets the target stopping position in the evacuation space. When notification of the result of determination that there is an evacuation space is not given, i.e., when there is not an evacuation space within the predetermined range of the current position of the vehicle 10, the vehicle control unit 33 sets the target stopping position on the road shoulder of the road section being traveled by the vehicle 10. The vehicle control unit 33 then controls components of the vehicle 10 so that the vehicle 10 stops at the target stopping position.

When there is an evacuation space within the predetermined range, the vehicle control unit 33 controls the power train and the brake devices after the start of the driving intervention phase so as to decelerate the vehicle 10 by a first amount of slowdown. When the vehicle 10 decelerates by a first amount of slowdown, the vehicle control unit 33 may set the accelerator opening to 0 to decelerate the vehicle 10 naturally. After decelerating, the vehicle control unit 33 makes the vehicle 10 travel to an entrance position into the evacuation space at a predetermined speed. When starting decelerating the vehicle 10, the vehicle control unit 33 may also honk the horn. In addition, when the host vehicle lane being traveled by the vehicle 10 differs from a lane from which the evacuation space can be entered (hereafter an “evacuation space lane”), the vehicle control unit 33 controls the steering wheel of the vehicle 10 to make a lane change of the vehicle 10 to the evacuation space lane before the vehicle 10 reaches the entrance position into the evacuation space. The vehicle control unit 33 identifies the host vehicle lane and the evacuation space lane by referring to the map information and the position of the vehicle 10 indicated by a positioning signal. Alternatively, the vehicle control unit 33 may detect individual lane lines on the road section being traveled by the vehicle 10, by inputting a vehicle exterior image into a classifier that has been trained to detect lane lines. The vehicle control unit 33 may then identify the number of lanes from the host vehicle lane to the evacuation space lane, based on the number of lane lines on the left or right of the vehicle 10.

The vehicle control unit 33 determines that the vehicle 10 has reached the entrance position into the evacuation space, when the position of the vehicle 10 indicated by a positioning signal has reached the entrance position into the evacuation space represented in the map information. Alternatively, the vehicle control unit 33 determines that the vehicle 10 has reached the entrance position into the evacuation space, when the size in a vehicle exterior image of a traffic sign indicating the entrance position into the evacuation space is greater than or equal to a predetermined size or when the bottom position of the sign in a vehicle exterior image is higher than a predetermined position. The vehicle control unit 33 detects a region representing the sign in a vehicle exterior image by inputting the vehicle exterior image into a classifier that has been trained to detect the sign. The classifier for detecting lane lines and the classifier for detecting a traffic sign are also configured as DNNs having CNN-type architecture or an attention mechanism. Alternatively, a single classifier may be pre-trained to detect both lane lines and a traffic sign.

When the vehicle 10 reaches the entrance position into the evacuation space, the vehicle control unit 33 makes the vehicle 10 start an entry action into the evacuation space. The entry action into the evacuation space is the action of steering the vehicle 10 into the evacuation space. After the start of the entry action into the evacuation space, the vehicle control unit 33 decelerates the vehicle 10 by a second amount of slowdown until the vehicle 10 stops, thereby stopping the vehicle 10 in the evacuation space.

In the present embodiment, the vehicle control unit 33 controls the power train and the brake devices of the vehicle 10 so that the second amount of slowdown of the vehicle 10 after the start of the entry action into the evacuation space is greater than the first amount of slowdown. Note that an amount of slowdown herein refers to the difference in speed before and after decelerating and is not the rate of change in speed at decelerating (deceleration). For example, assume that the speed of the vehicle 10 immediately before the start of the driving intervention phase is 60 km/h. In this case, the vehicle control unit 33 decelerates the vehicle 10 by 10 km/h as the first amount of slowdown, and thereafter makes the vehicle 10 travel at 50 km/h until the vehicle 10 reaches the entrance position into the evacuation space. After the start of the entry action into the evacuation space, the vehicle control unit 33 decelerates the vehicle 10 by 50 km/h as the second amount of slowdown to stop the vehicle 10. The first amount of slowdown may be set to 0 as long as the vehicle 10 can stop after entering the evacuation space even if the speed of the vehicle 10 immediately after the start of the driving intervention phase is maintained. For example, when the speed of the vehicle 10 immediately after the start of the driving intervention phase is less than or equal to the legal speed of the road section being traveled by the vehicle 10, the vehicle control unit 33 may set the first amount of slowdown to 0. In this way, the slowdown of the vehicle 10 is regulated until the vehicle 10 reaches the entrance position into the evacuation space, so that the time required for the vehicle 10 to reach the evacuation space shortens.

When there is not an evacuation space within the predetermined range of the current position of the vehicle 10, the vehicle control unit 33 decelerates the vehicle 10 by a third amount of slowdown greater than the first amount of slowdown. The vehicle control unit 33 keeps the vehicle 10 traveling at a low speed (e.g., 10 km/h) after the slowdown until the vehicle 10 enters the road shoulder, and searches the road shoulder for a stopping space where the vehicle 10 can stop. When a stopping space is found, the vehicle control unit 33 sets the stopping space as a target stopping position. In this way, the vehicle control unit 33 can stop the vehicle 10 safely even if there is not an evacuation space.

When searching for a space where the vehicle 10 can stop, the vehicle control unit 33 determines the presence or absence of an obstacle that hinders the vehicle 10 from stopping on the road shoulder, based on a vehicle exterior image obtained by the vehicle exterior camera 2. Such an obstacle is, for example, a human, a motorcycle, a vehicle, a signboard, a block, a pole, or a pylon. The vehicle control unit 33 detects an obstacle by inputting a vehicle exterior image into a classifier that has been trained to detect an obstacle. The classifier for detecting an obstacle is also configured as a DNN having CNN-type architecture or an attention mechanism. The vehicle control unit 33 determines a real-space region corresponding to a region that is included in an area corresponding to the road shoulder on the vehicle exterior image and that does not include a detected obstacle as a stopping space, and sets the stopping space as a target stopping position. To this end, the vehicle control unit 33 identifies the area corresponding to the road shoulder on the vehicle exterior image, based on the position of the vehicle 10 determined by a position determining device (not illustrated) mounted on the vehicle 10, the travel direction of the vehicle 10 measured by the orientation sensor (not illustrated) mounted on the vehicle 10, parameters of the vehicle exterior camera 2, such as the orientation and the angle of view, and the map information. Alternatively, the vehicle control unit 33 may identify the area corresponding to the road shoulder on the vehicle exterior image by detecting the road shoulder from the vehicle exterior image. In this case, the classifier for detecting an obstacle is pre-trained to detect the road shoulder as well. When the vehicle 10 includes a range sensor, such as a LiDAR sensor, the vehicle control unit 33 may detect an obstacle, based on a ranging signal obtained by the range sensor. In this case also, the vehicle control unit 33 can detect an obstacle by inputting a ranging signal into a classifier that has been trained to detect an obstacle. When an obstacle is detected, the vehicle control unit 33 determines whether the obstacle is on the road shoulder by referring to the direction and distance to the obstacle indicated by the ranging signal, the position and orientation of the vehicle 10, and the distance from the position of the vehicle 10 to the road shoulder in the direction where the obstacle exists.

When a target stopping position is found, the vehicle control unit 33 controls components of the vehicle 10 to stop the vehicle 10 at the target stopping position. When the host vehicle lane differs from the lane from which the road shoulder can be entered, the vehicle control unit 33 controls the steering wheel of the vehicle 10 to make a lane change of the vehicle 10 to the lane from which the road shoulder can be entered before the vehicle 10 reaches the target stopping position, as in the case where the host vehicle lane differs from an evacuation space lane.

In addition, the vehicle control unit 33 controls the vehicle 10 so that the vehicle 10 does not collide with any of obstacles around the vehicle 10 until the vehicle 10 stops.

The vehicle control unit 33 tracks obstacles around the vehicle 10 detected, for example, from time-series vehicle exterior images, and estimates predicted trajectories of the respective obstacles to a predetermined time ahead from the trajectories obtained from the result of tracking. Specifically, the vehicle control unit 33 applies a predetermined tracking process, such as Byte Track, to the series of vehicle exterior images to track the obstacles.

For each obstacle being tracked, the vehicle control unit 33 executes viewpoint transformation, using parameters of the vehicle exterior camera 2 such as the position of mounting on the vehicle 10, thereby transforming the image coordinates of the obstacle into coordinates in an aerial image (“aerial image coordinates”). To this end, the vehicle control unit 33 can estimate the position of the detected obstacle at the time of acquisition of each image, using the position of the vehicle 10 measured by the position determining device, the travel direction of the vehicle 10 measured by the orientation sensor, an estimated distance to the detected obstacle, and the direction from the vehicle 10 to the obstacle at the time of acquisition of each image. The bottom position of an object region representing a detected obstacle is supposed to correspond to the position at which the obstacle is on the road surface. Thus the vehicle control unit 33 can determine the estimated distance to the detected obstacle, based on the bottom position of the object region in the vehicle exterior image and parameters of the vehicle exterior camera 2, such as the orientation and the height of the mounted position. Alternatively, the vehicle control unit 33 may determine the distance measured by the range sensor in the direction corresponding to the object region representing the detected obstacle as the estimated distance to the detected obstacle. For each obstacle being tracked, the vehicle control unit 33 can estimate the trajectory of the obstacle by arranging the estimated positions in chronological order. The vehicle control unit 33 can then estimate predicted trajectories of the obstacles being tracked to a predetermined time ahead by executing a prediction process with, for example, a Kalman filter or a particle filter, based on the trajectories of the obstacles in a most recent predetermined period.

The vehicle control unit 33 controls components of the vehicle 10 (the power train, brake devices, and steering wheel), based on the predicted trajectories of the obstacles being tracked, so that predicted distances between the vehicle 10 and the obstacles will be greater than or equal to a predetermined distance until the predetermined time ahead. For example, assume that the vehicle 10 travels along the current path at the current speed and acceleration/deceleration, and that one of the detected obstacles moves along a predicted trajectory of the obstacle. Then, the vehicle control unit 33 decelerates the vehicle 10 or changes the travel direction of the vehicle 10, in the case where the vehicle 10 is predicted to collide with the obstacle, and where an estimated time until the collision is not longer than a predetermined collision determination time. To this end, the vehicle control unit 33 may decelerate the vehicle 10 by more than the first amount of slowdown, as necessary, before the start of the entry action into the evacuation space.

When the vehicle 10 stops, the vehicle control unit 33 unlocks the doors and keeps honking the horn in an aid phase. The vehicle control unit 33 may report the driver's abnormality via a wireless communication terminal (not illustrated) mounted on the vehicle 10.

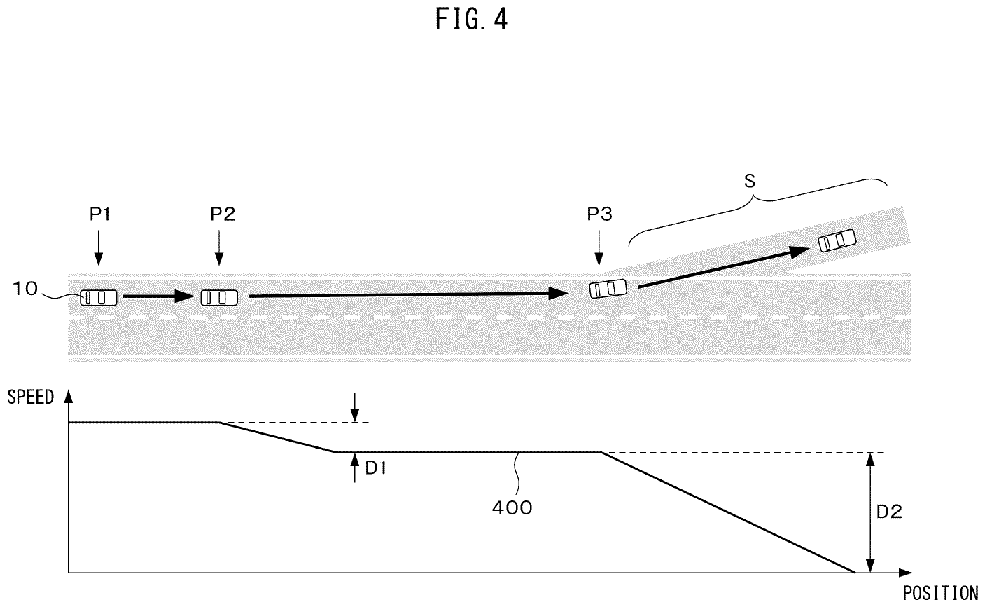

FIG. 4 is a diagram for explaining the vehicle control process for the case where there is an evacuation space. In FIG. 4, a graph 400 represents changes in the speed of the vehicle 10 as a function of position. In this example, when the vehicle 10 is at a position P1, the driver's abnormality is detected and execution of emergency stop mode is started. Thereafter, the control announcement phase is executed until the vehicle 10 reaches a position P2. After the vehicle 10 reaches the position P2, the driving intervention phase starts, in which the vehicle 10 decelerates by a first amount of slowdown D1. Thereafter, when the vehicle 10 reaches an entrance position P3 into an evacuation space S, the vehicle 10 enters the evacuation space, and then decelerates by a second amount of slowdown D2 and stops. In this way, when there is an evacuation space, the vehicle 10 is controlled so that the second amount of slowdown D2 is greater than the first amount of slowdown D1.

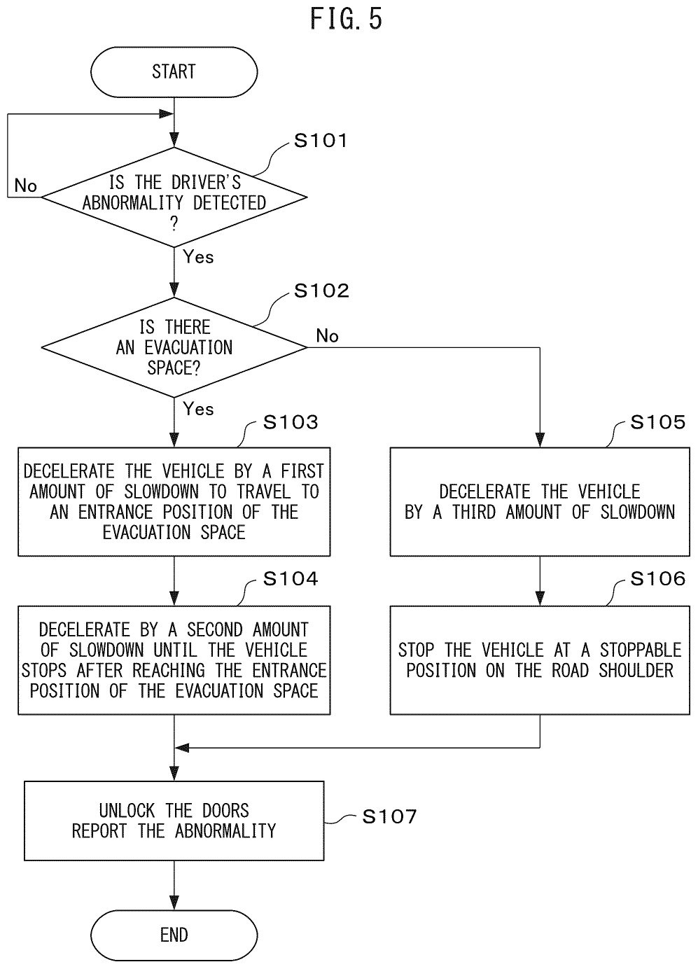

FIG. 5 is an operation flowchart of the vehicle control process executed by the processor 23.

The abnormality detection unit 31 determines whether the driver's abnormality is detected (step S101). When the driver's abnormality is not detected (No in step S101), the processor 23 repeats the processing of step S101.

When the driver's abnormality is detected (Yes in step S101), the determination unit 32 determines whether there is an evacuation space within a predetermined range of the current position of the vehicle 10 (step S102). When there is an evacuation space (Yes in step S102), the vehicle control unit 33 decelerates the vehicle 10 by a first amount of slowdown before the vehicle 10 reaches an entrance position into the evacuation space (step S103). When the vehicle 10 starts entering the evacuation space, the vehicle control unit 33 decelerates the vehicle 10 by a second amount of slowdown greater than the first amount of slowdown to stop the vehicle 10 (step S104).

When there is not an evacuation space (No in step S102), the vehicle control unit 33 decelerates the vehicle 10 by a third amount of slowdown greater than the first amount of slowdown (step S105). Thereafter, the vehicle control unit 33 searches the road shoulder for a stopping space where the vehicle 10 can stop, and stops the vehicle 10 in the stopping space (step S106).

After step S104 or S106, the vehicle control unit 33 unlocks the doors and reports the driver's abnormality (step S107). The processor 23 then terminates the vehicle control process.

As has been described above, when making an emergency stop of the vehicle in response to detection of the driver's abnormality, the vehicle controller controls the vehicle so that a first amount of slowdown of the vehicle before starting an entry action to make the vehicle enter an evacuation space to which the vehicle can evacuate is less than a second amount of slowdown from the start of the entry action to the stop of the vehicle. The vehicle controller can therefore shorten the time until the vehicle reaches the evacuation space, and thus shorten the time required from sensing of the driver's abnormality until the vehicle stops.

According to a modified example, the vehicle control unit 33 may set a collision avoidance condition for starting an avoidance action to avoid the vehicle 10 colliding with another object so that the collision avoidance condition is more relaxed after the start of the entry action into the evacuation space than before the start of the entry action. For example, the vehicle control unit 33 can relax the collision avoidance condition by setting a detection threshold used for detecting an obstacle after the start of the entry action into the evacuation space lower than before the start of the entry action. This is because a lower detection threshold facilitates detection of an object to be detected. Alternatively, the vehicle control unit 33 may relax the collision avoidance condition by setting the collision determination time after the start of the entry action into the evacuation space longer than before the start of the entry action. Relaxing the collision avoidance condition in this way reduces the occurrence of collisions of the vehicle 10 with an obstacle even if no evacuation space is prepared.

The computer program for achieving the vehicle control process of the above-described embodiment or modified example may be provided in recorded form on a computer-readable portable storage medium.

As described above, those skilled in the art may make various modifications according to embodiments within the scope of the present invention.

What is claimed is:

1. A vehicle controller comprising:
a memory configured to store map information including information on an evacuation space to which a vehicle can evacuate; and
a processor configured to:
detect abnormality occurring in a driver of the vehicle,
determine whether the evacuation space exists within a predetermined range of a current position of the vehicle, when abnormality occurring in the driver is detected, by referring to the map information or by recognizing a traffic sign indicating the existence of the evacuation space from a vehicle exterior image obtained by a vehicle exterior camera configured to capture an area around the vehicle, and
control the vehicle when the evacuation space exists within the predetermined range so that the vehicle stops in the evacuation space and that a first amount of slowdown of the vehicle before starting an entry action to make the vehicle enter the evacuation space is less than a second amount of slowdown from the start of the entry action to the stop of the vehicle.

2. The vehicle controller according to claim 1, wherein when the evacuation space does not exist within the predetermined range, the processor decelerates the vehicle by a third amount of slowdown greater than the first amount of slowdown, searches for a stopping space where the vehicle can stop, based on the vehicle exterior image, and stops the vehicle in the stopping space.

3. The vehicle controller according to claim 1, wherein the processor sets a collision avoidance condition for starting an avoidance action to avoid the vehicle colliding with another object so that the collision avoidance condition is more relaxed after the start of the entry action than before the start of the entry action.

4. A method for vehicle control, comprising:
detecting abnormality occurring in a driver of a vehicle;
determining whether an evacuation space to which the vehicle can evacuate exists within a predetermined range of a current position of the vehicle, when abnormality occurring in the driver is detected, by referring to map information including information on the evacuation space or by recognizing a traffic sign indicating the existence of the evacuation space from a vehicle exterior image obtained by a vehicle exterior camera configured to capture an area around the vehicle; and
controlling the vehicle when the evacuation space exists within the predetermined range so that the vehicle stops in the evacuation space and that a first amount of slowdown of the vehicle before starting an entry action to make the vehicle enter the evacuation space is less than a second amount of slowdown from the start of the entry action to the stop of the vehicle.

5. A non-transitory recording medium that stores a computer program for vehicle control, the computer program causing a processor mounted on a vehicle to execute a process comprising:
detecting abnormality occurring in a driver of the vehicle;
determining whether an evacuation space to which the vehicle can evacuate exists within a predetermined range of a current position of the vehicle, when abnormality occurring in the driver is detected, by referring to map information including information on the evacuation space or by recognizing a traffic sign indicating the existence of the evacuation space from a vehicle exterior image obtained by a vehicle exterior camera configured to capture an area around the vehicle; and
controlling the vehicle when the evacuation space exists within the predetermined range so that the vehicle stops in the evacuation space and that a first amount of slowdown of the vehicle before starting an entry action to make the vehicle enter the evacuation space is less than a second amount of slowdown from the start of the entry action to the stop of the vehicle.
